(19) United States
(12) Patent Application Publication
(10) Pub. No.: US 2002/0152388 A1
(43) Pub. Date: Oct. 17, 2002

(54) Method and arrangement for enabling disintermediation, and receiver for use thereby

(76) Inventors: Johan Paul Marie Gerard Linnartz, Eindhoven (NL); Robert Leslie Van Oostenbrugge, Eindhoven (NL); Gerardus Cornelis Petrus Lokhoff, Eindhoven (NL); Jakobus Middeljans, Eindhoven (NL); Paulus George Maria De Bot, Eindhoven (NL)

Correspondence Address: U.S. Philips Corporation, 580 White Plains Road, Tarrytown, NY, 10591, US

(21) Appl. No.: 10/082,856

(22) Filed: Oct. 19, 2001

(30) Foreign Application Priority Data
Oct. 20, 2000 (EP) 00203659.8

(51) Int. Cl. H04L 9/00

(52) U.S. Cl. 713/176; 705/51

(57) ABSTRACT

A method of enabling disintermediation in a business model, as well as an arrangement (100) therefor. Extra information related to the business model is embedded in content such as music, which is then distributed via a third party (202) to a rendering device (204). The rendering device (204) generates an audible signal (120) that can be picked up by a receiver (220) such as a mobile phone. The receiver (220) processes the signal (120) to obtain the embedded information, which is then used in the course of the business model.

The invention relates to a method of enabling disintermediation in a business model. The invention further relates to an arrangement for enabling disintermediation, and to a receiver for use therein.

In prior art business models, it is often difficult or impossible for a business to directly reach consumers. This is particularly true for businesses providing information services. Traditionally, providing such services to consumers requires the cooperation of intermediate entities such as broadcasters and television manufacturers. Such cooperation usually comes at a price.

As an example, consider a movie producer who wishes to promote a movie. To this end, he produces a trailer, which is to be transmitted to consumers. Normally, a consumer who views the trailer and decides he wants to go see the movie then needs to access some information service to find out which cinemas show the movie and at which times.

The distributor of the trailer may provide this information to the consumer, for instance as a Teletext page listing all available movies and starting times, or as a mention in a local television show or advertisement. However, the distributor will most likely charge a fee for making this information available using his Teletext channel.

While this does make sense for the distributor, it is disadvantageous for the content owner since it reduces his own profits. He would like to cut out the middleman and directly provide his service to the consumer. This is known generally as disintermediation: removing the intermediary from the value chain. In the prior art this is only marginally possible. For example, the content owner could pay a television network to include the information for his service and avoid paying the cable network as well, since the television network presumably already has a deal with the cable network for the distribution of content. However, the content owner would like to avoid paying anyone at all, if possible.

It is an object of the invention to provide a method according to the preamble, which provides enhanced disintermediation in a business model.

This object is achieved according to the invention in a method comprising embedding extra information related to the business model in content, distributing the content with the embedded information via a third party to a rendering device for output to a receiver arranged for processing the embedded information in the course of the business model.

Watermarking, the process of inserting extra information in an input signal such as audio or video, is an important and well-known technique to mark or protect those input signals. A movie can be watermarked so its origin can be identified, or unauthorized copies can be distinguished from the original. Watermarks can be used with still images to locate copies reproduced by unauthorized third parties, by simply downloading images from the information services offered by those third parties and examining the downloaded images for the watermark.

Watermarks can also be used to embed metadata, such as an Internet Uniform Resource Locator (URL), in the input signal, for instance in a movie. A user who views the movie at his personal entertainment station can access the embedded metadata to access, for instance, the World-Wide Web site of the movie.

Watermarks can also contain metadata related to e-commerce, such as a Uniform Resource Identifier. The content owner then arranges for an audio signal representing the audio content to be transmitted, for example by broadcasting it, to a consumer. The consumer can retrieve and use the metadata by using e.g. his mobile phone as a receiver for the audio signal, and then detecting the watermark from the received audio signal and processing the metadata comprised therein.

A content owner and a mobile phone vendor, or the content owner and a mobile phone operator can now work out various watermarking-based e-commerce business models without any involvement of the broadcaster, network operator or the manufacturer of the CE appliance. This provides true disintermediation. Preferably the extra information is related to an e-commerce application. The receiver is then preferably arranged for participating in the e-commerce application.

In a further embodiment the extra information is embedded in the content by means of a watermark. Using an audio watermark at a point where a consumer can receive the signal in which it is embedded has the advantage that it can be picked up easily, for instance by simply aiming a mobile device, such as a mobile phone, at a loudspeaker which emits the watermarked audio signal.

In a further embodiment the output is in the acoustical domain. This has the advantage that the signal can now be picked up by anyone by simply aiming a microphone towards the output. This makes it very easy to participate in the business model.

In a further embodiment the receiver comprises a mobile phone. Many consumers have a mobile phone, and so it is a logical choice to use a mobile phone as receiver in a consumer business model. A mobile phone can also easily communicate with other devices, such as e-commerce servers, which makes it easy to integrate it in a value chain or to provide interactive services using the embedded extra information as a starting point.

It is a further object of the invention to provide an arrangement that provides enhanced disintermediation in a business model.

This object is achieved according to the invention in an arrangement comprising a content source for embedding extra information related to the business model in content, a distributor for distributing the content with the embedded information to a rendering device for output to a receiver arranged for processing the embedded information in the course of the business model.

It is a further object of the invention to provide a receiver for use in the arrangement according to the invention.

According to the invention the receiver comprises receiving means for receiving a signal comprising extra information related to a business model, decoding means for extracting the extra information from the signal, and processing means for processing the embedded information in the course of the business model.

In an embodiment the receiver is arranged for transmitting at least a portion of the output to a supporting server and for receiving from the supporting server the extra information that was embedded in the portion.

The receiver may be embodied as a mobile phone, and it is to be expected that most portable receivers will only have limited capabilities. The mobile phone may then be assisted in detecting, decoding and/or processing by a supporting server. The mobile phone in that case is only used to carry the audio from the pickup point to the central processing server. This has the advantage that only little processing power is required in the mobile phone.

The invention further relates to a computer program enabling a programmable device when executing said computer program product to function as the receiving device.

These and other aspects of the invention will be apparent from and elucidated with reference to the embodiments shown in the drawing, in which:

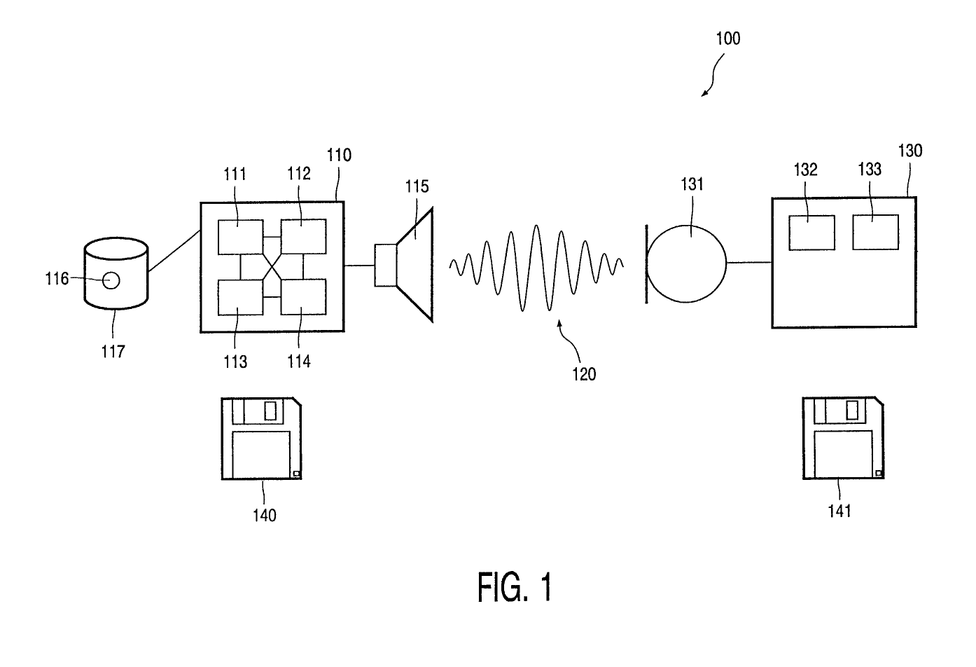

FIG. 1 schematically shows a first embodiment of the arrangement according to the invention; and

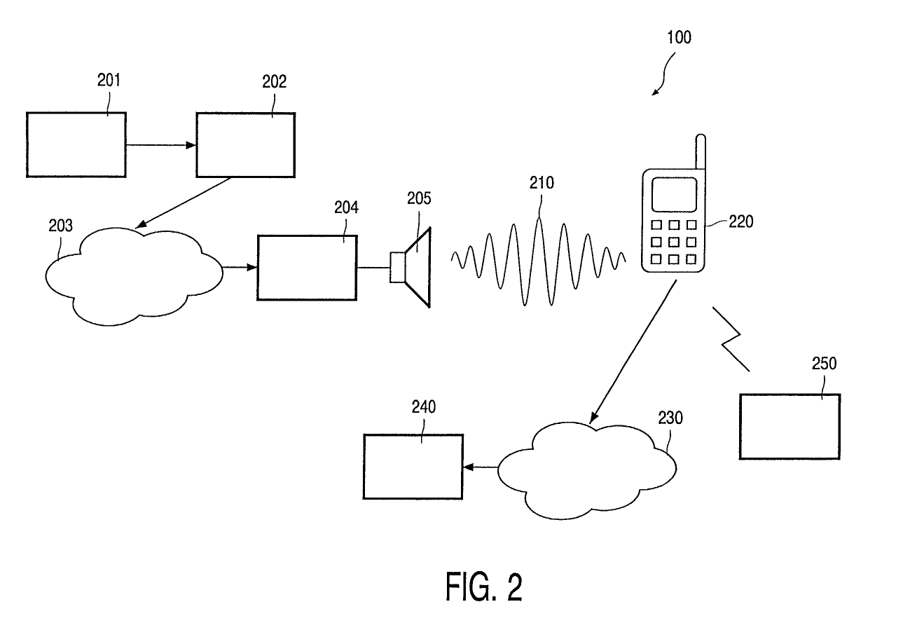

FIG. 2 schematically shows a second embodiment of the arrangement.

Throughout the figures, same reference numerals indicate similar or corresponding features. Some of the features indicated in the drawings are typically implemented in software, and as such represent software entities, such as software modules or objects.

FIG. 1 schematically shows an arrangement 100 for distributing content. The arrangement 100 comprises a watermarking device 110, a rendering device 115 and a receiving device 130. The watermarking device 110 comprises determining module 111, generating module 112, embedding module 113, and watermarking module 114.

The watermarking device 110 is, in accordance with the invention, arranged to watermark content 116 that is to be distributed to the receiving device 130. The content 116 is for instance a television program, a radio program, a movie, an advertisement, a picture or a sound or a portion thereof. The content 116 should have extra information embedded into it before it is transmitted. The determining module 111 determines the extra information to be inserted by means of a watermark. Any type of extra information can be embedded in this fashion. Some examples will be given below. Alternatively, the extra information may have been inserted beforehand by a supplier of the content 116.

The generating module 112 receives a selection of the content 116 and generates a signal representing the content 116. The content 116 is usually received through a network such as the Internet, a satellite feed or a home network from a distributor such as a television broadcasting organization. Alternatively, it can be loaded from local storage 117, which can be a tape or a disk such as a DVD or Video CD. It can also be a hard disk on which it has been previously recorded for later viewing.

The embedding module 113 generates a watermark in which the extra information is embedded. This watermark is to be communicated to the receiving device 130 together with the content 116, so preferably the watermark is generated based on the content 116 or its representation.

The extra information may need to be embedded in a synchronized fashion with the activity in the content 116, so that they will be synchronized with this activity as well. In other situations, the extra information may need to be processed or used at particular points in time. In those situations, the expected rendering times of the content 116 should be known so that the extra information can be embedded at the corresponding locations in the representation.

The watermarking module 114 generates the watermarked signal 120 comprising the signal representing the content 116 and the watermark signal, using any kind of watermarking or other steganographic technique appropriate for the content 116. The watermarked content 116 is then transmitted to the rendering device 115, which upon receipt generates a watermarked signal 120, preferably as an audio signal.

It is preferred to provide the user with an unobtrusive indication that extra information is available, for example with a visual icon shown in one of the corners of a visual output module, if available, or by outputting an audio message over rendering device 115.

The receiving device 130 comprises receiving module 131, decoding module 132 and executing module 133. The receiving module 131 receives the signal 120 and feeds it to the decoding module 131. The receiving module 131 can be for instance a microphone, a camera or a light sensitive sensor of some kind.

The decoding module 131 obtains the content 116 from the signal 120. Typically receiving and decoding comprises converting the signal 120 back into a representation similar to the one used in the watermarking device 110. The decoding module 131 then processes the content 116 to obtain the extra information.

The executing module 133 executes some action based on the extra information. In one embodiment the extra information comprises an Internet URL, and the executing module 133 then automatically retrieves the associated webpage from the Internet. In another embodiment the extra information is related to a product. The executing module 133 then executes an application that allows its user to buy the product from an e-commerce system. Other actions are of course also possible.

The watermarking device 110 can be realized as a computer program product 140 being arranged for causing a processor to execute the method described above. The computer program product 140 enables a programmable device when executing said computer program product to function as the watermarking device 110. Similarly, the receiving device 130 can be realized as a computer program product 141 enabling a programmable device when executing said computer program product to function as the receiving device 130.

The above description gives a general overview of the functionality of distributing watermarked content. Various ways are possible to realize the watermarking device 110 and the receiving device 130, with different advantages and possibilities. The arrangement 100 can be used to realize any present or future business model or application using the watermark as a means of reaching the consumer. This will be discussed below.

FIG. 2 shows a second embodiment of the arrangement 100 according to the invention. There is a content provider 201, a distributing entity 202, a distributing network 203, a receiving device 204 coupled to a rendering device 205 and a portable receiver 220.

The content provider 201 has some piece of content that needs to be transmitted to a consumer. The content preferably comprises audio content, but may also comprise video content. It is the intention of the content provider 201 to realize some business model involving intended recipients of the content. To this end, the content provider 201 embeds extra information in the content by means of watermarking. The content can be watermarked using any watermarking technique suitable for the type of content that is to be transmitted. To this end, the content provider 201 employs a device such as the watermarking device 110 described above with reference to FIG. 1.

The content owner 201 then transmits the watermarked content to a distributing entity 202. The distributing entity 202 is responsible for distributing the content to the intended recipients, which may be anyone with a suitable receiving device. The distributing entity 202 may optionally distribute the content only to subscribers or receivers who pay using a prepay card or other mechanism.

To reach the intended receivers, the distributing entity 202 makes use of facilities offered by various network operators. Using a network operator, the content is transported over distribution network 203 to a rendering device 204, which for instance is a set-top box at a consumer's house, but can also be a public address system in any location. The rendering device 204 is arranged to play out the content over output device 205. To this end, the rendering device 204 produces signal 210, which is in the acoustical domain.

The consumer can choose to simply listen to the signal 210, but he may also want to make use of the extra information embedded in it. In that case, he simply has to use his portable receiver 220, such as his mobile phone, to receive the signal 210.

The portable receiver 220 decodes the watermark from the received signal 210 and processes the extra information contained therein. This extra information is then used to realize a business application, as will become apparent below.

In one embodiment, only the portable receiver 220 is necessary at the consumer's end to realize the business model or e-commerce application. However, it is to be expected that most portable receivers 220 will only have limited capabilities. The portable receiver 220 may then be assisted in detecting, decoding and/or processing by a supporting server 250, which can be in the mobile network 230 but may also be located in the user's home or at some other place.

The portable receiver 220 can communicate with an e-commerce server 240 using a network 230 of some kind. For instance, if the portable receiver 220 is a mobile phone, the network 230 is the mobile network coupled to a network such as the Internet, allowing the mobile phone to connect to servers such as server 240 on the Internet.

Using this arrangement, the content owner 201 can work out and realize any present or future business model or application using the watermark as a means of reaching the consumer. The distributing entity 202 and the operator of network 203 are not required to do anything special. Thus, the arrangement according to the invention provides true disintermediation—it is no longer necessary to involve a distributor and a network operator to reach a consumer.

As an example business model, consider a content owner 201 who wishes to promote a movie. To this end, he produces a trailer, which is to be transmitted to consumers. Normally, a consumer who views the trailer and decides he wants to go see the movie then needs to access some information service to find out which cinemas show the movie and at which times. The distributor 202 may provide this information to the consumer, for instance as a Teletext page listing all available movies and starting times, or as a mention in a local television show or advertisement. However, the distributor 202 will most likely charge a fee for making this information available using his Teletext channel.

In accordance with the invention, the content owner 201 can embed the information in the audio portion of the trailer. The distributor 202 then distributes the trailer as usual, and when the rendering device 204 shows it, the consumer can aim his mobile phone 220 at the loudspeaker 205 to pick up the audio portion. The mobile phone 220 then detects the watermark and decodes the information embedded therein. It can then show an overview of cinemas and starting times on its display. Preferably, the mobile phone 220 knows which city the consumer lives in and filters the information prior to displaying it.

Alternatively, the extra information watermarked in the audio portion of the trailer comprises a Uniform Resource Identifier (URI) identifying a Webpage on the Internet, which shows the overview of cinemas and starting times. The mobile phone 220 then detects the watermark, decodes the URL therefrom and retrieves the Webpage, for instance using the Wireless Application Protocol (WAP). By browsing the Webpage on his mobile phone 220, the consumer can then choose the right cinema and time.

Another example business model that can be realized using the invention is a scheme to promote the viewing of commercials. The content owner 201 can produce commercials with embedded watermarks which are to be presented to consumers. The extra information embedded in those watermarks is in this business model related to a prize contest of some sort. Consumers can then use their mobile phone 220 or other suitably equipped portable device to pick up the extra information to see if they have won a prize. The prize can be represented by an electronic code, which must be entered in an information system to determine if the consumer has won a prize.

The content owner 201 now embeds this electronic code in one particular commercial, to be broadcast at one particular time, and announces this fact without mentioning the exact time and place. Consumers who want to win the prize now have to watch all the commercials from this content owner 201 to try to detect the watermark with the electronic code. This greatly increases the brand exposure for the content owner 201 and stimulates the viewing of commercials in general.

In another business model, the content owner 201 embeds advertisements, preferably related to the content, in the content by means of a watermark. The mobile phones 220 which receive the content, decode the watermark and present the advertisements to the user.

In another business model, the content owner 201 embeds information related to a product or service in the content by means of a watermark. This is particularly attractive in situations like exhibits or markets, where audio content is already broadcast. For instance, a booth at an exhibit can use a public address system to broadcast audio messages to anyone in the neighborhood, and embeds information on the product shown in the booth in those messages. The messages serve to attract the attention of the public, and members of the public can access the embedded information by having their mobile phone 220 pick up the watermarked audio and decode the information therefrom.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of enabling disintermediation in a business model, comprising embedding extra information related to the business model in content (116), distributing the content (116) with the embedded information via a third party (202) to a rendering device (204) for output (120) to a receiver (220) arranged for processing the embedded information in the course of the business model.

2. A method as claimed in claim 1, whereby the extra information is related to an e-commerce application.

3. A method as claimed in claim 2, whereby the receiver (220) is arranged for participating in the e-commerce application.

4. A method as claimed in claim 1, whereby the extra information is embedded in the content (116) by means of a watermark.

5. A method as claimed in claim 1, whereby the output (120) is in the acoustical domain.

6. A method as claimed in claim 1, whereby the receiver (220) comprises a mobile phone.

7. An arrangement (100) for enabling disintermediation in a business model, comprising a content source (201) for embedding extra information related to the business model in content (116), a distributor (202) for distributing the content (116) with the embedded information to a rendering device (204) for output (120) to a receiver (220) arranged for processing the embedded information in the course of the business model.

8. A receiver (220) for use in the arrangement of claim 7, comprising receiving means (131) for receiving a signal (120) comprising extra information related to a business model, decoding means (132) for extracting the extra information from the signal (120), and processing means (133) for processing the embedded information in the course of the business model.

9. The receiver (220) of claim 8, being arranged for transmitting at least a portion of the output (120) to a supporting server (250) and for receiving from the supporting server (250) the extra information that was embedded in the portion.

10. A computer program product (141) comprising receiving means (131) for receiving a signal (120) comprising extra information related to a business model, decoding means (132) for extracting the extra information from the signal (120), and processing means (133) for processing the embedded information in the course of the business model.
